(19) United States
(12) Patent Application Publication
(10) Pub. No.: US 2025/0206025 A1
(43) Pub. Date: Jun. 26, 2025

(54) LIQUID EJECTING APPARATUS, FORMING APPARATUS, CONTROL METHOD, AND ARTICLE MANUFACTURING METHOD

(71) Applicant: CANON KABUSHIKI KAISHA, Tokyo (JP)

(72) Inventors: HISASHI NAMBA, Tochigi (JP); TAKAHIRO HOSOKAWA, Tochigi (JP)

(21) Appl. No.: 18/958,638

(22) Filed: Nov. 25, 2024

(30) Foreign Application Priority Data
Dec. 26, 2023 (JP) 2023-218796

(51) Int. Cl. B41J 2/165; B29C 43/18; B29C 43/34; B41J 2/045; B41J 2/175; B41J 2/18; B41J 2/19

(52) U.S. Cl. CPC B41J 2/16526; B29C 43/18; B29C 43/34; B41J 2/0451; B41J 2/04581; B41J 2/04588; B41J 2/16579; B41J 2/17563; B41J 2/17596; B41J 2/18; B41J 2/19; B29C 2043/3433

(57) ABSTRACT

A liquid ejecting apparatus includes: an accommodation unit configured to accommodate an ejection liquid; an ejection unit including a plurality of nozzles ejecting the ejection liquid; a circulation unit configured to circulate the ejection liquid of an individual flow passage in the nozzle; and a control unit configured to draw in and remove foreign matters with which an ejection port of the nozzle has become clogged inside by applying a foreign-matter drawing waveform to a piezoelectric element included in the nozzle, and then cause the circulation unit to circulate the ejection liquid of the individual flow passage in the nozzle and discharge the foreign matters from the individual flow passage.

### BACKGROUND OF THE INVENTION

### Field of the Invention

The present invention relates to a liquid ejecting apparatus, a forming apparatus, a control method, and an article manufacturing method.

### Description of the Related Art

In liquid ejecting apparatuses that eject liquids, piezoelectric elements are driven to eject the liquids from minute ejection ports. These minute ejection nozzles can become clogged with foreign matters, which cause ejection failures.

Japanese Patent Application Laid-open No. 2015-112851 discloses a method of removing foreign matters adhered to outside portions of nozzle openings by driving piezoelectric elements and pushing liquids outward from nozzle ports.

In Japanese Patent Application Laid-open No. 2015-112851, however, in the method of removing foreign matters adhered to outside portions of the nozzle openings by driving the piezoelectric elements and pushing liquids outward from nozzle ports, it is difficult to remove foreign matters with which ejection ports are clogged from the inside.

### SUMMARY OF THE INVENTION

According to an aspect of the present invention,

a liquid ejecting apparatus includes an accommodation unit configured to accommodate an ejection liquid; an ejection unit including a plurality of nozzles ejecting the ejection liquid; a circulation unit configured to circulate the ejection liquid of an individual flow passage in the nozzle; and a control unit configured to draw in and remove foreign matters with which an ejection port of the nozzle has become clogged inside by applying a foreign-matter drawing waveform to a piezoelectric element included in the nozzle, and then cause the circulation unit to circulate the ejection liquid of the individual flow passage in the nozzle and discharge the foreign matters from the individual flow passage.

Further features of the present invention will become apparent from the following description of embodiments with reference to the attached drawings.

### BRIEF DESCRIPTION OF THE DRAWINGS

FIG. 1 is a diagram illustrating a configuration example of a liquid ejecting apparatus according to a first embodiment of the present invention.

FIG. 2 is a diagram illustrating an overall configuration example of a nozzle according to the first embodiment.

FIG. 3 is a flowchart illustrating a control method of recovering from an abnormal nozzle according to the first embodiment.

FIGS. 4A to 4D are diagrams illustrating a state of an individual flow passage when the abnormal nozzle is recovered according to the first embodiment.

FIGS. 5A and 5B are diagrams illustrating examples of foreign-matter drawing waveforms applied to a piezoelectric element of a nozzle according to the first embodiment.

FIG. 6 is a diagram illustrating a first bubble removing method in an accommodation unit according to the first embodiment.

FIG. 7 is a diagram illustrating a second bubble removing method in an accommodation unit according to a second embodiment.

### DESCRIPTION OF THE EMBODIMENTS

Hereinafter, with reference to the accompanying drawings, favorable modes of the present invention will be described using Embodiments. In each diagram, the same reference signs are applied to the same members or elements, and duplicate description will be omitted or simplified.

### First Embodiment

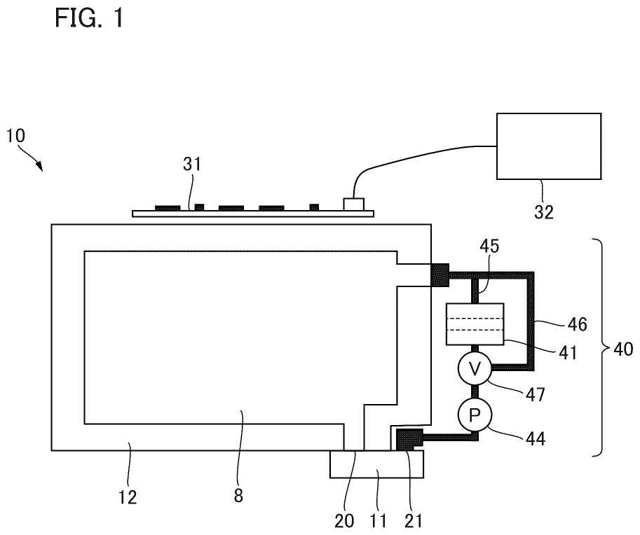

FIG. 1 is a diagram illustrating a configuration example of a liquid ejecting apparatus according to a first embodiment of the present invention. A liquid ejecting apparatus 10 includes an ejection unit 11, an accommodation unit 12, a driver board 31, an ejection liquid 8 that is ejected from the ejection unit 11, and a circulation unit 40 that circulates an ejection liquid of an individual flow passage in a nozzle.

The liquid ejecting apparatus 10 is used to apply an ejection liquid such as an imprint material to a substrate in a forming apparatus such as an imprint apparatus or a flattening apparatus. In the forming apparatus, after an ejection liquid is applied to the substrate by the liquid ejecting apparatus 10, a mold is brought into contact with the ejection liquid on the substrate, and then the ejection liquid is irradiated with ultraviolet light, heat, or the like for hardening, so that a predetermined pattern or a flattened surface is formed.

The accommodation unit 12 is a container that accommodates the ejection liquid 8 and is connected to the ejection unit 11. The ejection liquid 8 is supplied from a supply port 20 to the ejection unit 11. The ejection unit 11 includes a plurality of nozzles for ejecting the ejection liquid 8 and can eject the ejection liquid 8 from each nozzle via the supply port 20.

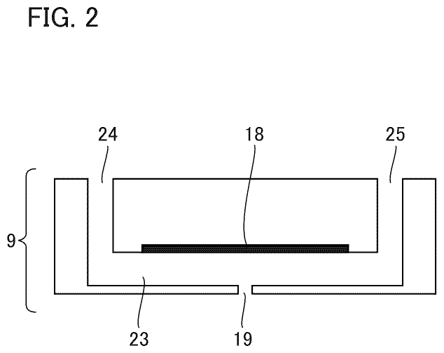

FIG. 2 is a diagram illustrating an overall configuration example of a nozzle according to the first embodiment, and each nozzle 9 in the ejection unit 11 is enlarged and illustrated. The ejection liquid 8 supplied to each nozzle via the supply port 20 of the ejection unit 11 is supplied to an individual flow passage 23 of each nozzle via an individual flow passage supply port 24 of each nozzle. Reference number 25 denotes an individual flow passage outlet.

The ejection liquid 8 supplied to the individual flow passage 23 is ejected from the ejection port 19 provided near the center of the individual flow passage 23. An opening area of the ejection port 19 is less than an opening area of the individual flow passage supply port 24 and a cross-sectional area is minimized in a flow passage in the nozzle 9.

To eject the ejection liquid 8 as a liquid droplet from the ejection port 19, an energy generation element is provided at a position facing the ejection port 19.

As the energy generation element, a piezoelectric element or a heating resistor can be exemplified. As the ejection liquid, a liquid that contains a considerable resin is used. Here, a piezoelectric element 18 is used as the energy generation element.

A command to control ejection is given from the control unit 32 to the driver board 31. An output of the driver board 31 is connected to the piezoelectric element 18 of each nozzle of the liquid ejecting apparatus 10, and a voltage waveform for ejecting a liquid droplet is given to the piezoelectric element 18 of a designated nozzle to eject the liquid droplet.

The control unit 32 contains a CPU or the like serving as a computer and controls an operation of each unit of the entire liquid ejecting apparatus 10 based on a computer program stored in a memory serving as a storage medium. The control unit 32 may be provided in the liquid ejecting apparatus 10 or may be provided outside of the liquid ejecting apparatus 10.

In the present embodiment, the piezoelectric element 18 is also used to determine a clogging state of the ejection port 19. That is, in the liquid ejecting apparatus according to the embodiment, a voltage of 30% to 70% of a voltage applied to the piezoelectric element 18 at the time of ejecting of the ejection liquid 8 is applied to vary a volume (hereinafter referred to as an inspection oscillation) of the individual flow passage 23 so that vibration is added to the ejection liquid 8 in the individual flow passage 23.

In a variation width of the voltage, vibration can be given to the ejection liquid 8 in the individual flow passage 23, but a meniscus of the ejection port 19 is not broken and the ejection liquid 8 is not ejected from the ejection port 19. Even after the voltage applied to the piezoelectric element 18 is stopped, residual vibration remains in the individual flow passage. Since deformation is caused in the piezoelectric element 18 due to the residual vibration, a counter electromotive force is generated in the piezoelectric element 18.

When the ejection port 19 has become clogged with a deposition or when bubbles have entered into the individual flow passage 23, a resonant frequency in the individual flow passage 23 is different from that of a normal ejection state. When a voltage is applied to the piezoelectric element 18 to vibrate a liquid in the individual flow passage 23, residual vibration also becomes different.

Therefore, a nozzle clogging detection unit according to the present embodiment detects that the ejection port 19 of the nozzle is clogged with foreign matters and bubbles have entered the individual flow passage 23 by measuring the residual vibration in the individual flow passage 23 by a counter electromotive force of the piezoelectric element 18.

In the present embodiment, at a timing at which an ejection operation is not performed, a clogging state of the ejection port 19 is detected through the inspection oscillation of the piezoelectric element 18. When abnormality is found, the process proceeds to an abnormal nozzle recovering step to be described below. When there is no abnormality, the state becomes a ready state in which the liquid can be ejected at any time.

In the present embodiment, an ejection-failed nozzle is detected through inspection oscillation. A landing inspection apparatus (not illustrated) may measure presence or absence of landing, a landing position, a landing speed, or a landing amount to detect an ejection-failed nozzle.

The ejection unit 11 is open to the atmosphere through the ejection port 19, but a diameter of the ejection port 19 is in the range of a few μm to tens of μm. When the outer surface of a nozzle port is in a liquid-repellent state, the ejection liquid 8 does not leak out due to the own weight. A liquid level near the ejection port 19 is maintained in a concave shape that is a so-called meniscus state.

The ejection unit 11 is connected to the supply port 20 and a discharge port 21, and the ejection liquid 8 supplied from the supply port 20 to each individual flow passage 23 is discharged from the discharge port 21 via each individual flow passage outlet 25.

Reference numeral 40 denotes a circulation unit that circulates an ejection liquid of an individual flow passage in the nozzle. The discharge port 21 is connected to a passage 45 of the circulation unit 40. A pump 44, a three-way valve 47, and a filter 41 are connected to the passage 45. A flow oriented from the pump 44 to the filter 41 is formed by the pump 44.

The three-way valve 47 is designed to flow the ejection liquid 8 from the pump 44 to the filter 41 normally. When the pump 44 is driven, the ejection liquid 8 in the accommodation unit 12 passes through the discharge port 21 from the supply port 20 via the individual flow passage 23 and is filtered by the filter 41. The filtered ejection liquid 8 returns to the accommodation unit 12 again, and thus cleanness of the ejection liquid 8 in the accommodation unit 12 is improved. Reference numeral 46 denotes a bypass flow passage 46

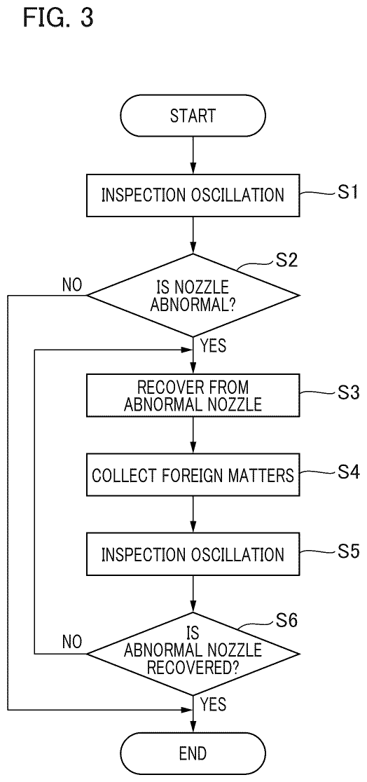

FIG. 3 is a flowchart illustrating a control method of recovering from an abnormal nozzle according to the first embodiment. A CPU or the like serving as a computer in the control unit 32 executes a computer program stored in a memory, so that an operation of each step of the flowchart of FIG. 3 is sequentially performed.

In step S1 of FIG. 3, the CPU of the control unit 32 performs inspection oscillation of the piezoelectric element 18 of each nozzle simultaneously or a predetermined order at the time of ejection waiting. Here, step S1 functions as a nozzle clogging detection step (nozzle clogging detection unit) of detecting that the nozzle is clogged with foreign matters.

Step S1 is performed in each period in which an imprint operation is not performed, for example, when a periodic imprint operation is performed in an imprint apparatus or the like. Alternatively, step S1 is performed in each predetermined period for periodic maintenance of the imprint apparatus or an exchange case of the accommodation unit.

In step S2, the CPU of the control unit 32 determines whether clogging of each nozzle occurs based on a result of the inspection oscillation. When No is determined, that is, it is determined that any nozzle is not abnormal, the flow illustrated in FIG. 3 ends.

When Yes is determined in step S2, that is, it is determined that any one nozzle is abnormal, the process proceeds to an abnormal nozzle recovering step of step S3.

In step S3, the CPU of the control unit 32 applies a drawing waveform to only the piezoelectric element 18 of the nozzle determined to be abnormal in step S2. That is, the control unit applies a foreign-matter drawing waveform to the nozzle detected to be clogged with the foreign matters by the nozzle clogging detection unit. Accordingly, the foreign matters are moved from the ejection port 19 and the foreign matters in the individual flow passage 23 are moved.

In the present embodiment, in step S3, the drawing waveform is not applied to the nozzle in which there is no abnormality. Therefore, it is possible to prevent unnecessary bubbles from occurring. An internal motion of the individual flow passage 23 when the drawing waveform is applied will be described below.

In step S4, the CPU of the control unit 32 performs a foreign matter collecting process. That is, after the foreign matters in the nozzle are removed, foreign matters 26 in the individual flow passage 23 are moved into the accommodation unit 12 by a pump. Thereafter, the foreign matters 26 in the accommodation unit 12 are removed by a filter by driving the pump. Bubbles in the accommodation unit 12 are also removed. The foreign-matter collecting step will also be described below.

Steps S3 and S4 function as a control step. In the control step, the control unit draws in and removes the foreign matters with which the ejection portion of the nozzle is clogged inside by applying the foreign-matter drawing waveform to the piezoelectric element included in the nozzle. Thereafter, the foreign matters are discharged from the individual flow passage by circulating the ejection liquid of the individual flow passage in the nozzle by the circulation unit.

In step S5, the CPU of the control unit 32 determines whether the abnormal nozzle is recovered in step S6 by performing the inspection oscillation on the nozzle determined to be abnormal in step S2.

That is, after the foreign matters with which the ejection port of the nozzle is clogged inside are drawn and removed, it is determined in step S6 whether the clogging of the nozzle is eliminated. When it is determined in step S6 that the abnormal nozzle is not recovered, the process returns to step S3. When Yes is determined in step S6, the flow of FIG. 3 ends.

In the imprint apparatus, when it is determined in step S2 that the nozzle is abnormal, the recovery flow of the abnormal nozzle is performed and a time of, for example, 10 minutes passes. Accordingly, a substrate on which the imprint operation is performed is exchanged with a new substrate and the imprint operation resumes from a first imprint region of the exchanged new substrate.

That is, in the forming apparatus such as an imprint apparatus, the liquid ejecting apparatus ejects the ejection liquid to the substrate, and then a forming control unit (not illustrated) performs a process of forming an ejection liquid by bringing a mold into contact with the ejection liquid on the substrate. When the foreign matters with which the ejection port of the nozzle is clogged inside are drawn and removed and then it is determined that the clogging of the nozzle is eliminated, the forming control unit exchanges the substrate with a new substrate and resumes the forming process.

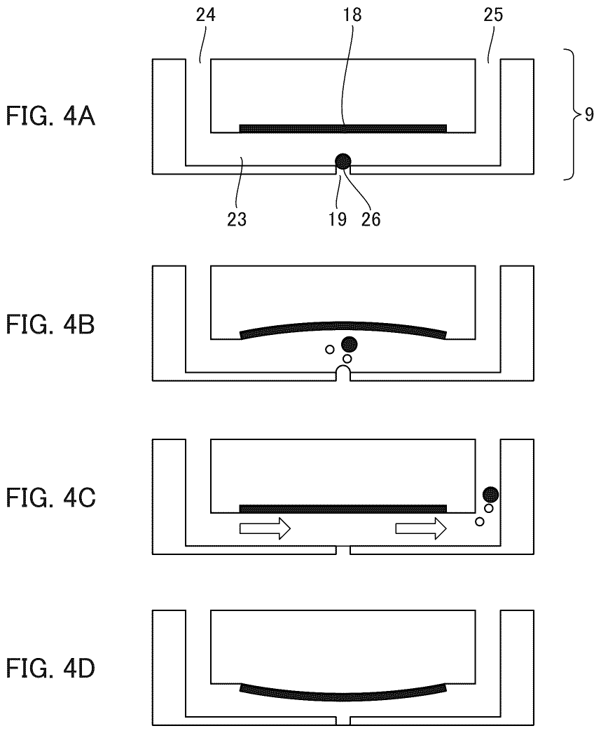

Next, FIGS. 4A to 4D are diagrams illustrating a state of an individual flow passage when the abnormal nozzle is recovered according to the first embodiment. An internal motion of the individual flow passage 23 in step S3 when the drawing waveform is applied will be described with reference to FIGS. 4A to 4D.

FIG. 4A illustrates a state in which the ejection port 19 is clogged with the foreign matters 26. The foreign matters 26 are in the accommodation unit 12 or the individual flow passage 23, and the ejection liquid 8 in the accommodation unit 12 flows toward the ejection port 19 as the ejection liquid 8 is ejected from the ejection port 19.

Then, when the ejection liquid 8 is ejected from the ejection port 19, the foreign matters 26 fit in the ejection port 19 from the inside. Since the foreign matters 26 fit in the inside of the ejection port 19, the foreign matters 26 cannot be pushed out although the foreign matters 26 are pushed out from the inside of the ejection port 19. To remove the foreign matters 26 from the ejection port 19, it is necessary to first drawn the foreign matters 26 into the individual flow passage 23 from the ejection port 19.

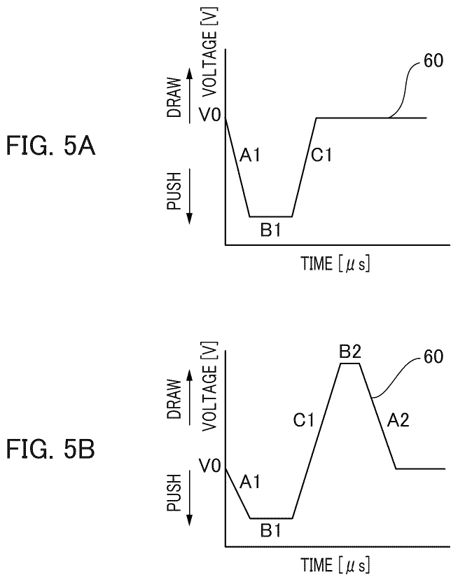

This method will be described with reference to FIGS. 4B, 5A, and 5B. FIGS. 5A and 5B are diagrams illustrating examples of foreign-matter drawing waveforms applied to the piezoelectric element 18 of the nozzle according to the first embodiment. FIG. 5A illustrates a foreign-matter drawing waveform 60 for drawing the foreign matters 26 into the individual flow passage 23.

The foreign-matter drawing waveform 60 includes a pushing waveform A1 for pushing the ejection liquid 8 (first pushing waveform), a waiting waveform B1 (first waiting waveform), and a drawing waveform C1 for drawing the ejection liquid 8 (maximum drawing waveform).

First, with the pushing waveform A1, an operation of pushing a meniscus out of the ejection port 19 is performed. At this time, since the ejection port 19 is clogged with the foreign matters 26, the individual flow passage 23 vibrates in a resonance period (a period of a resonant frequency) T1 when the ejection port 19 is clogged with the foreign matters. When the meniscus is pushed with the pushing waveform A1, the individual flow passage 23 becomes positively pressurized and the pressure is reversed after about T1/4 and starts to be negative.

Accordingly, with the waiting waveform B1, a time of T1/4 is waited and the drawing waveform C1 is applied in synchronization with a timing at which the pressure is reversed. The piezoelectric element 18 is bent to be opposite to the ejection port 19, a strong negative pressure can be given into the individual flow passage, and thus a force of drawing the foreign matters 26 more strongly can be provided in the individual flow passage 23.

In the present embodiment, to make the drawing force stronger, a voltage change amount of the drawing waveform C1 is set to be the same as a voltage change amount of the pushing waveform A1 or greater than the voltage change amount of the pushing waveform A1.

That is, in the present embodiment, the foreign-matter drawing waveform 60 includes a maximum drawing waveform (drawing waveform C1) in which a voltage change amount is the maximum and a first pushing waveform (pushing waveform A1) before the maximum drawing waveform, and a voltage change amount of the first pushing waveform is set to be equal to or less than the voltage change amount of the maximum drawing waveform. Here, voltage change amounts per time of the first pushing waveform and the maximum drawing waveform are substantially the same and magnitudes of the voltage change amounts are compared.

An optimum waiting time of the waiting waveform B1 (first waiting waveform) is ¼ of the resonance period T1. When T1/6<=waiting time of the waiting waveform B1<=T1/3, an effect of foreign matter removal can be obtained. That is, the first waiting waveform is included between the maximum drawing waveform and the first pushing waveform, and, the waiting time (first waiting time) of the first waiting waveform may be set to T/6 or more and T/3 or less when T is a resonance period of an individual flow passage.

In the present embodiment, by synchronizing a timing of a reaction at the time of drawing after the pushing with such a waiting waveform, it is possible to remove the foreign matters more strongly.

When the ejection port 19 is clogged with the foreign matters 26, the ejection port 19 is not completely clogged, and the resonance period T1 at the time of the clogging with the foreign matters 26 is not considerably different from a resonance period TO at the time of no clogging. Therefore, the waiting time may be T0/4 based on the resonance period TO when the foreign matters 26 are not clogged during a waiting period of the waiting waveform B1. Alternatively, T0/6<=waiting waveform B1<=T0/3 may be set.

Another example of the foreign-matter drawing waveform 60 will be described with reference to FIG. 5B. The presence of the pushing waveform A1 (first pushing waveform), the waiting waveform B1 (first waiting waveform), and the drawing waveform C1 (maximum drawing waveform) is the same as those of FIG. 5A, and a period of the waiting waveform B1 is ¼ of the resonance period T1 of the individual flow passage 23. In FIG. 5B, since a drawing force is made to be stronger, a voltage change amount of the drawing waveform C1 is set to be greater than a voltage change amount of the pushing waveform A1.

Here, sucking strongly with the pushing waveform C1 may be likely to result in a large amount of bubbles. Accordingly, in the example of FIG. 5B, a waiting waveform B2 (second waiting waveform) is inserted, a time of about 1/20 of the resonance period T1 is awaited, and then the ejection liquid 8 is pushed with the pushing waveform A2 (second pushing waveform) to reduce mixing of bubbles.

By providing the pushing waveform A2 after the drawing waveform C1 in this way, it is possible to reduce mixing of bubbles when the voltage change amount of the maximum drawing waveform C1 is the same or greater than the voltage change amount of the previous pushing waveform A1.

The voltage change amount of the maximum drawing waveform C1 (maximum drawing waveform) is set to be greater than the voltage change amount of the subsequent pushing waveform A2 (second pushing waveform). That is, the foreign-matter drawing waveform includes a maximum drawing waveform and a second pushing waveform after the maximum drawing waveform, and a voltage change amount of the maximum drawing waveform is set to be greater than a voltage change amount of the second pushing waveform.

A waiting time (second waiting time) of the waiting waveform B2 (second waiting waveform) is preferably about 1/20 of the resonance period T1. Even in the case of T1/40<=second waiting time <=T2/10, the effect of the foreign matter removal can be obtained. Here, the longer the period of the waiting waveform B2 is, the easier bubbles occur.

That is, the second waiting waveform is included between the maximum drawing waveform and the second pushing waveform, and the waiting time of the second waiting waveform may be T/40 or more and T/10 or less when T is a resonance period of an individual flow passage.

By repeatedly applying the foreign-matter drawing waveform 60 to an abnormal nozzle, it is possible to remove foreign matters gradually. For example, the foreign matters are removed by applying the drawing waveform illustrated in FIG. 5A or 5B, for example, 100 times.

When the foreign matters 26 are drawn from the ejection port 19 by a strong drawing force into the individual flow passage 23, as described above, as in FIG. 4B, the foreign matters 26 are entered into the individual flow passage 23. At the same time, bubbles are also drawn into the individual flow passage 23 by a strong negative pressure.

In the present embodiment, an operation of collecting the foreign matters 26 and the bubbles is performed. That is, as illustrated in FIG. 4C, the foreign matters 26 and the bubbles in the individual flow passage 23 are removed by making a flow from the individual flow passage supply port 24 to the individual flow passage output port 25.

FIG. 4D is a diagram illustrating an example of a state in which a predetermined pushing waveform is applied to the piezoelectric element 18. By forming the state illustrated in FIG. 4D after FIG. 4C, the ejection liquid 8 is pushed to fill the nozzle port with the ejection liquid 8.

An operation of making a flow illustrated in FIG. 4C according to the present embodiment will be described. As described above, the three-way valve 47 is designed to flow the liquid from the pump 44 to the filter 41 when the foreign matter removing operation is not involved. By driving the pump 44, the ejection liquid 8 in the accommodation unit 12 passes through the discharge port 21 from the supply port 20 via the individual flow passage 23 and is filtered by the filter 41.

When the ejection liquid 8 is circulated from the nozzle during ejection by the pump 44, a pressure of the individual flow passage 23 may be changed and an ejection speed and an ejection amount of the ejection liquid 8 may also be changed. Therefore, the ejection liquid 8 is not circulated during the ejection by the pump 44.

In the present embodiment, thereafter, when the foreign-matter drawing waveform 60 is applied for abnormal nozzle recovery, as described in FIGS. 4B, 5A, and 5B, the bubbles are entered into the individual flow passage 23. Accordingly, when the pump 44 is subsequently driven and the bubbles are circulated as they are, the bubbles in the individual flow passage 23 may enter the filter 41. For example, in the case of a filter of about 100 nm, the bubbles entering the filter 41 do not pass through the filter 41 and the filter 41 is clogged.

Therefore, in the present embodiment, when an operation of removing the foreign matters 26 is performed with the foreign-matter drawing waveform 60, a direction of the three-way valve 47 is changed to flow the foreign matters or the bubbles in the individual flow passage 23 to the bypass flow passage 46 so that the bubbles do not go to the filter 41. In this way, the foreign matters 26 or the bubbles in the individual flow passage 23 are entered into the accommodation unit 12 via the bypass flow passage 46. Then, the bubbles gather in an upper portion of the accommodation unit 12 and the foreign matters 26 drift in the ejection liquid 8 in the accommodation unit 12.

Thereafter, by returning back the three-way valve 47 so that the liquid flows from the pump 44 to the filter 41 and driving the pump 44, it is possible to remove the foreign matters 26 by the filter 41. At this time, the bubbles remain in the upper portion of the accommodation unit 12, and thus the filter 41 is not clogged.

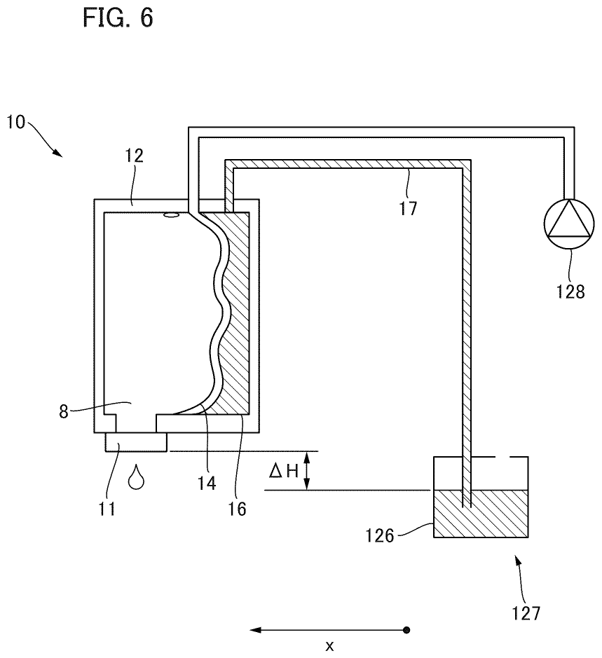

Next, a method of removing bubbles will be described with reference to FIG. 6. FIG. 6 is a diagram illustrating a first bubble removing method in the accommodation unit according to the first embodiment and illustrating a state when the liquid ejecting apparatus 10 in FIG. 1 is viewed from the side.

In the accommodation unit 12, a separation membrane 14 including two flexible members that separate a space in the accommodation unit is provided. The separation membrane 14 preferably includes by two films that has a thickness of 10 μm or more and 200 μm or less and is formed of a material that has a low liquid penetration property.

The separation membrane 14 can be formed of a film of fluororesin material such as PFA or a composite multi-layer film in which fluororesin material and plastic material are combined. A space between the two flexible members forming the separation membrane 14 is sucked by a vacuum pump 128, and thus the two flexible members are not separated.

The accommodation unit 12 that is one of units divided by the separation membrane 14 of the accommodation unit 12 accommodates the ejection liquid 8, and a filling liquid accommodation unit 16 that is the other unit accommodates a filling liquid. The accommodation unit 12 and the filling liquid accommodation unit 16 are separated by the separation membrane 14.

The filling liquid accommodation unit 16 is connected to a meniscus control unit 127 by a pipe 17. The meniscus control unit 127 is connected to a supply tank 126 for a filing liquid via the pipe 17. An upper portion of the supply tank 126 is open to the atmosphere and a liquid level in the supply tank 126 is at the atmosphere pressure.

The liquid level of the filling liquid in the supply tank 126 is controlled such that the liquid level is located at a position lower by ΔH [mm] than the liquid level of the ejection port 19. In this case, an internal pressure of the ejection port 19 is controlled to a value (minute negative pressure) lower by ΔH×0.01 [kP] than the outside air pressure to maintain a meniscus.

When ejection of the ejection liquid 8 from the ejection unit 11 is repeated, the ejection liquid 8 in the accommodation unit 12 is consumed and reduced, and thus the separation membrane 14 is gradually deformed in the +x direction. As the separation membrane 14 is deformed, the filling liquid is replenished from a filling liquid tank to the filling liquid accommodation unit 16 by a pressure control unit (not illustrated).

Since the filling liquid of the filling liquid accommodation unit 16 is reduced, control is performed such that the filling liquid is replenished to the filling liquid accommodation unit 16 by a pump (not illustrated) to maintain the difference ΔH between a liquid level height of the filling liquid of the supply tank 126 and the ejection port 19.

Accordingly, it is possible to stabilize the shape of the meniscus in the ejection unit 11, and thus well reproduce ejection of the ejection liquid 8.

The bubbles captured in the accommodation unit 12 in the abnormal nozzle recovering step of step S3 are accumulated in the upper portion of the accommodation unit 12. When there is a large amount of gas in the accommodation unit 12, the pressure control cannot be performed. However, an amount of bubbles captured from a number of nozzles due to vibration of the piezoelectric element 18 as in the abnormal nozzle recovering step does not significantly affect the pressure control.

Since the space in the separation membrane 14 is depressurized by the vacuum pump 128 and the film of the separation membrane 14 transmits some gases, the gasses dissolved in the ejection liquid 8 in the accommodation unit 12 are degassed. That is, the bubbles inside the accommodation unit 12 are removed via the separation membrane contacting with the ejection liquid 8. Since a dissolved gas concentration of the ejection liquid 8 in the accommodation unit 12 decreases, the bubbles in the accommodation unit 12 gradually dissolve into the ejection liquid 8 and eventually disappear.

In this way, according to the present embodiment, it is possible to provide the liquid ejecting apparatus capable of removing foreign matters with which the ejection port of the nozzle is clogged.

### Second Embodiment

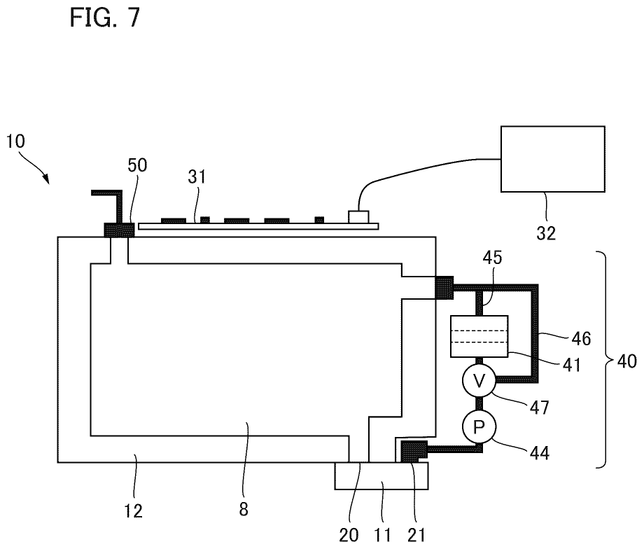

Next, a method of removing bubbles according to a second embodiment is illustrated in FIG. 7. FIG. 7 is a diagram illustrating a second bubble removing method in an accommodation unit according to a second embodiment. A bubble vent valve 50 for removing bubbles inside the accommodation unit is disposed in an upper portion of the accommodation unit 12. By opening the bubble vent valve 50 after the abnormal nozzle recovering step of step S3, it is possible to discharge the bubbles accumulated in the upper portion of the accommodation unit 12.

### Embodiment of Article Manufacturing Method

A liquid ejecting apparatus or a control method according to the first embodiment and the second embodiment are appropriate for manufacturing, for example, a microdevice such as a semiconductor device or an article such as an element that has a minute structure.

A method of manufacturing a device (a semiconductor device, a magnetic storage medium, a liquid crystal display element, or the like) as an article will be described.

The manufacturing method includes an applying step of applying the ejection liquid to a substrate in a forming apparatus using the liquid ejecting apparatus according to the first embodiment and the second embodiment, and a forming step of forming the ejection liquid by bringing a mold into contact with the substrate to which the ejection liquid has been applied and hardening the ejection liquid. Further, the manufacturing method includes a manufacturing step of manufacturing an article from the substrate on which the ejection liquid is formed in the forming step.

That is, the method of manufacturing the article includes a step of transferring a pattern of the mold to a surface of a substrate (a wafer, a glass plate, a film-shaped substrate, or the like) using the forming apparatus. The step of transferring the pattern of the mold may include a flattening step. The substrate is not limited to a base material substrate and may include a substrate with a multi-layered structure.

The manufacturing method may include a step of forming a latent image pattern in a photosensitive agent applied to the substrate using an exposure apparatus (a step of exposing the substrate) or a step of developing the substrate on which the latent image pattern has been formed in the step.

The manufacturing method further includes a processing step of processing the substrate before or after the pattern transferring step. The processing step may include, for example, a step of removing a remaining film of the pattern.

The processing step may include a step of etching the substrate using the pattern as a mask, a step (dicing) of cutting a chip from the substrate, or a step (bonding) of disposing the chip in a frame and electrically connecting the chip. The processing step may include a known step such as a step (molding) of performing sealing with a resin.

In the method of manufacturing an article to which the first or second embodiment is applied, it is possible to reduce abnormality of nozzles for ejecting the ejection liquid compared to the related art. Therefore, the method is advantageous for at least one of performance, quality, productivity, and production cost of an article.

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to the liquid ejecting apparatus or the like through a network or various storage media. Then, a computer (or a CPU, an MPU, or the like) of the liquid ejecting apparatus or the like may be configured to read and execute the program. In such a case, the program and the storage medium storing the program configure the present invention.

In addition, the present invention includes those realized using at least one processor or circuit configured to perform functions of the embodiments explained above. For example, a plurality of processors may be used for distribution processing to perform functions of the embodiments explained above.

This application claims the benefit of priority from Japanese Patent Application No. 2023-218796, filed on Dec. 26, 2023, which is hereby incorporated by reference herein in its entirety.

1. A liquid ejecting apparatus comprising:
an accommodation unit configured to accommodate an ejection liquid;
an ejection unit including a plurality of nozzles ejecting the ejection liquid;
a circulation unit configured to circulate the ejection liquid of an individual flow passage in the nozzle; and
at least one processor or circuit configured to function as a control unit configured to draw in and remove foreign matters with which an ejection port of the nozzle has become clogged inside by applying a foreign-matter drawing waveform to a piezoelectric element included in the nozzle, and then cause the circulation unit to circulate the ejection liquid of the individual flow passage in the nozzle and discharge the foreign matters from the individual flow passage.

2. The liquid ejecting apparatus according to claim 1,
wherein the at least one processor or circuit is further configured to function as a nozzle clogging detection unit configured to detect clogging of foreign matters in the nozzle, and
wherein the control unit applies the foreign-matter drawing waveform to the nozzle for which the nozzle clogging detection unit detects the clogging of the foreign matters.

3. The liquid ejecting apparatus according to claim 2, wherein the nozzle clogging detection unit detects the clogging of the foreign matters in the nozzle by measuring residual vibration in the individual flow passage by a counter electromotive force of the piezoelectric element.

4. The liquid ejecting apparatus according to claim 1, wherein the foreign-matter drawing waveform includes a maximum drawing waveform and a first pushing waveform before the maximum drawing waveform, and a voltage change amount of the first pushing waveform is equal to or less than a voltage change amount of the maximum drawing waveform.

5. The liquid ejecting apparatus according to claim 4, wherein a first waiting waveform is included between the maximum drawing waveform and the first pushing waveform, and a waiting time of the first waiting waveform is T/6 or more and T/3 or less when T is a resonance period of the individual flow passage.

6. The liquid ejecting apparatus according to claim 1, wherein the foreign-matter drawing waveform includes a maximum drawing waveform and a second pushing waveform after the maximum drawing waveform, and a voltage change amount of the maximum drawing waveform is greater than a voltage change amount of the second pushing waveform.

7. The liquid ejecting apparatus according to claim 6, wherein a second waiting waveform is included between the maximum drawing waveform and the second pushing waveform, and a waiting time of the second waiting waveform is T/40 or more and T/10 or less when T is a resonance period of the individual flow passage.

8. The liquid ejecting apparatus according to claim 1, wherein the foreign matters in the nozzle are removed, and then bubbles in the accommodation unit are removed.

9. The liquid ejecting apparatus according to claim 8, wherein the bubbles in the accommodation unit are removed via a separation membrane contacting with the ejection liquid.

10. The liquid ejecting apparatus according to claim 1, wherein the accommodation unit includes a bubble vent valve for removing bubbles in the accommodation unit.

11. The liquid ejecting apparatus according to claim 1, wherein the control unit determines whether the clogging of the nozzle is eliminated after the foreign matters clogged inside the ejection port of the nozzle is drawn and removed.

12. A forming apparatus comprising:
an accommodation unit configured to accommodate an ejection liquid;
an ejection unit including a plurality of nozzles ejecting the ejection liquid;
a circulation unit configured to circulate the ejection liquid of an individual flow passage in the nozzle; and
at least one processor or circuit configured to function as a control unit that draws in and remove foreign matters with which an ejection port of the nozzle has become clogged inside by applying a foreign-matter drawing waveform to a piezoelectric element included in the nozzle, and then cause the circulation unit to circulate the ejection liquid of the individual flow passage in the nozzle and discharge the foreign matters from the individual flow passage, and a forming control unit configured to perform a process of bringing a mold into contact with the ejection liquid on a substrate and forming the ejection liquid after the ejection unit ejects the ejection liquid to the substrate.

13. The forming apparatus according to claim 12, wherein, when the foreign matters clogged inside the ejection port of the nozzle are drawn and removed and then it is determined that the clogging of the nozzle is eliminated, the forming control unit resumes the forming after exchange of the substrate with a new substrate.

14. A control method of controlling a liquid ejection apparatus including an accommodation unit that accommodates an ejection liquid, an ejection unit that includes a plurality of nozzles ejecting the ejection liquid, and a circulation unit that circulates the ejection liquid of an individual flow passage in the nozzle, the method comprising:
a control step of drawing in and removing foreign matters with which an ejection port of the nozzle has become clogged inside by applying a foreign-matter drawing waveform to a piezoelectric element included in the nozzle, and then causing the circulation unit to circulate the ejection liquid of the individual flow passage in the nozzle and discharging the foreign matters from the individual flow passage.

15. An article manufacturing method using a liquid ejection apparatus including an accommodation unit that accommodates an ejection liquid, an ejection unit that includes a plurality of nozzles ejecting the ejection liquid, and a circulation unit that circulates the ejection liquid of an individual flow passage in the nozzle, the method comprising:
a control step of drawing in and removing foreign matters with which an ejection port of the nozzle has become clogged inside by applying a foreign-matter drawing waveform to a piezoelectric element included in the nozzle, and then causing the circulation unit to circulate the ejection liquid of the individual flow passage in the nozzle and discharging the foreign matters from the individual flow passage;
an applying step of applying the ejection liquid to a substrate;
a forming step of forming the ejection liquid by bringing a mold into contact with the substrate to which the ejection liquid has been applied and hardening the ejection liquid; and
a manufacturing step of manufacturing an article from the substrate on which the ejection liquid is formed in the forming step.
